(19) United States
(12) Patent Application Publication
(10) Pub. No.: US 2025/0303672 A1
(43) Pub. Date: Oct. 2, 2025

(54) JOINED BODY AND JOINING METHOD

(71) Applicant: HONDA MOTOR CO., LTD., Tokyo (JP)

(72) Inventors: Masaaki FUJIMOTO, Saitama (JP); Kenichi FUKAMI, Saitama (JP); Seiya OKAMURA, Saitama (JP); Yuichiro OGAWA, Saitama (JP)

(21) Appl. No.: 19/018,244

(22) Filed: Jan. 13, 2025

(30) Foreign Application Priority Data
Mar. 29, 2024 (JP) 2024-055452

(51) Int. Cl. B32B 15/01; B23K 26/322; B23K 26/323; B23K 103/02; B23K 103/10; B23K 103/20

(52) U.S. Cl. CPC B32B 15/012; B23K 26/322; B23K 26/323; B23K 2103/02; B23K 2103/10; B23K 2103/20

(57) ABSTRACT

The present invention provides a joined body of an aluminum-based material made by high pressure die casting and a different material with sufficient joint strength. Provided is a joined body of a first member that is an aluminum-based material formed by high pressure die casting (HPDC) and a second member made of a material different from the first member. The first member has a melted-then-solidified part that is melted and then solidified and contains less gas than a non-melted part, and the first member has a joint that is located adjacent to one end of the first member which is away from the melted-then-solidified part, and joined to the second member.

This application is based on and claims the benefit of priority from Japanese Patent Application No. 2024-055452, filed on 29 Mar. 2024, the content of which is incorporated herein by reference.

### BACKGROUND OF THE INVENTION

### Field of the Invention

The present invention relates to a joined body and a joining method.

### Related Art

In recent years, there has been a growing demand for reduced CO₂ emissions and improved energy efficiency. One of the solutions to achieve such a demand is weight reduction of components. The weight reduction of the components can be achieved by, for example, dissimilar material joining, that is, part of a member made of a relatively high strength and high weight material such as a steel plate is replaced with a relatively lightweight material such as aluminum or magnesium.

Composite welding of an aluminum-based material and an iron-based material without using any brazing metal or flux has been disclosed as a technique of joining dissimilar materials (see Japanese Unexamined Patent Application, Publication No. 2006-281279). Also disclosed is a method for laser welding metal plates including at least one metal plate having a processed surface layer. In this method, the metal plates are welded together by melting the metal plates and evaporating the processed surface layer by laser irradiation of the metal plates along the shape to be welded (see Japanese Unexamined Patent Application, Publication No. 2012-115876).
Patent Document 1: Japanese Unexamined Patent Application, Publication No. 2006-281279
Patent Document 2: Japanese Unexamined Patent Application, Publication No. 2012-115876

### SUMMARY OF THE INVENTION

An aluminum-based material made by high pressure die casting (HPDC), which may be hereinafter referred to as a “HPDC aluminum material”, has been known as a welding target. HPDC is a manufacturing process that involves feeding molten metal into a die and solidifying the metal to obtain a desired part, and is widely used because parts of complicated shapes are produced and the production efficiency is high. On the other hand, the HPDC aluminum material is generally rich in gas (e.g., hydrogen), and a welded part has a large number of blowholes (pores). Thus, dissimilar materials joined together may lack joint strength.

According to the disclosure of Japanese Unexamined Patent Application, Publication No. 2006-281279, a first heat source that emits a laser to a surface of the iron-based material from the aluminum-based material side and a second heat source that heats the surface of the aluminum-based material in an overlapping part are used. The first heat source first melts a zinc-based coating layer near an end of the overlapping part only, and then the second heat source melts the zinc-based coating layer and the aluminum-based material in the overlapping part. If this method is applied to the joining of the HPDC aluminum material, the heat source for melting the zinc-based coating layer cannot melt the HPDC aluminum material, and thus the resulting joint disadvantageously remains gas-rich. If a heat source capable of melting the HPDC aluminum material is used, the HPDC aluminum material and the zinc-based coating layer are molten near the overlapping part, lowering the melting point of aluminum. This may draw aluminum into a newly generated surface and may excessively produce an intermetallic compound.

Japanese Unexamined Patent Application, Publication No. 2012-115876 describes the removal of the blowholes by evaporating a plating layer during welding, but is silent on how the gas contained in the base material is removed.

In view of the above circumstances, an object of the present invention is to provide a joined body of an aluminum-based material made by high pressure die casting and a different material with sufficient joint strength.

A first aspect of the present invention is directed to a joined body of a first member that is an aluminum-based material formed by high pressure die casting and a second member made of a material different from the first member. The first member has a melted-then-solidified part that is melted and then solidified and contains less gas than a non-melted part, and the first member has a joint that is located adjacent to one end of the first member which is away from the melted-then-solidified part, and joined to the second member.

In the first aspect, a joined body of an aluminum-based material made by high pressure die casting and a different material can be provided with sufficient joint strength.

According to a second aspect, in the joined body of the first aspect, the second member is made of an iron material and includes a base material and a plating layer formed on a surface of the base material. The plating layer has a boiling point higher than a melting point of the base material, and the joint is joined to a solid solution layer formed by solidifying at least part of a material forming the plating layer with the base material.

In the second aspect, the HPDC aluminum material is joined to the solid solution layer, that is, aluminum and iron are welded together. Thus, the joined body can be produced more easily than when the HPDC aluminum material is directly welded to the plating layer.

According to a third aspect, in the joined body of the first or second aspect, the first member and the second member are spaced from each other in a part other than the joint and at least near the joint.

In the third aspect, excessive formation of an intermetallic compound due to the melted-then-solidified part partially flowing into the solid solution layer during manufacture can be reduced, keeping the joint strength from decreasing.

According to a fourth aspect, in the joined body of any one of the first to third aspects, the first member has a stepped part so that the one end has a smaller cross sectional area than the other end.

In the fourth aspect, excessive formation of an intermetallic compound due to the melted-then-solidified part partially flowing into the solid solution layer during manufacture can be reduced, keeping the joint strength from decreasing.

A fifth aspect of the present invention is directed to a method for joining a first member that is an aluminum-based material formed by high pressure die casting (HPDC) and a second member made of a material different from the first member. The method includes: first melting one end part of the first member to form a first molten part; and second melting a further end part of the first member than the first molten part formed by the first melting to form a second molten part. The second molten part of the first member formed by the second melting is joined to the second member.

In the fifth aspect, a joined body of an aluminum-based material made by high pressure die casting and a different material can be provided with sufficient joint strength.

According to a sixth aspect, in the method of the fifth aspect, the second member is made of an iron material and includes a base material and a plating layer formed on a surface of the base material. The plating layer has a boiling point higher than a melting point of the base material. The first melting solidifies at least part of a material forming the plating layer with the base material to form a solid solution layer, and the second melting joins the second molten part to the solid solution layer.

In the sixth aspect, the HPDC aluminum material is joined to the solid solution layer, that is, aluminum and iron are welded together. Thus, the joined body can be produced more easily than when the HPDC aluminum material is directly welded to the plating layer. The first melting melts the plating layer and forms the first molten part simultaneously. This allows welding of dissimilar materials that are difficult to weld, that is, the high melting point plating material and the HPDC aluminum material, by melting these materials twice.

According to a seventh aspect, in the method of the sixth aspect, the second melting joins the second molten part to the solid solution layer after a surface temperature of the solid solution layer falls below its melting point.

In the seventh aspect, excessive formation of an intermetallic compound of iron and aluminum can be reduced.

### BRIEF DESCRIPTION OF THE DRAWINGS

FIG. 1 is a sectional view schematically illustrating a joined body according to a first embodiment;

FIG. 2 is a sectional view schematically illustrating a joined body according to a second embodiment;

FIG. 3 is a view illustrating a step of manufacturing the joined body according to the first embodiment; and

FIG. 4 is a view illustrating a step of manufacturing the joined body according to the first embodiment.

### DETAILED DESCRIPTION OF THE INVENTION

### <Joined Body>

### First Embodiment

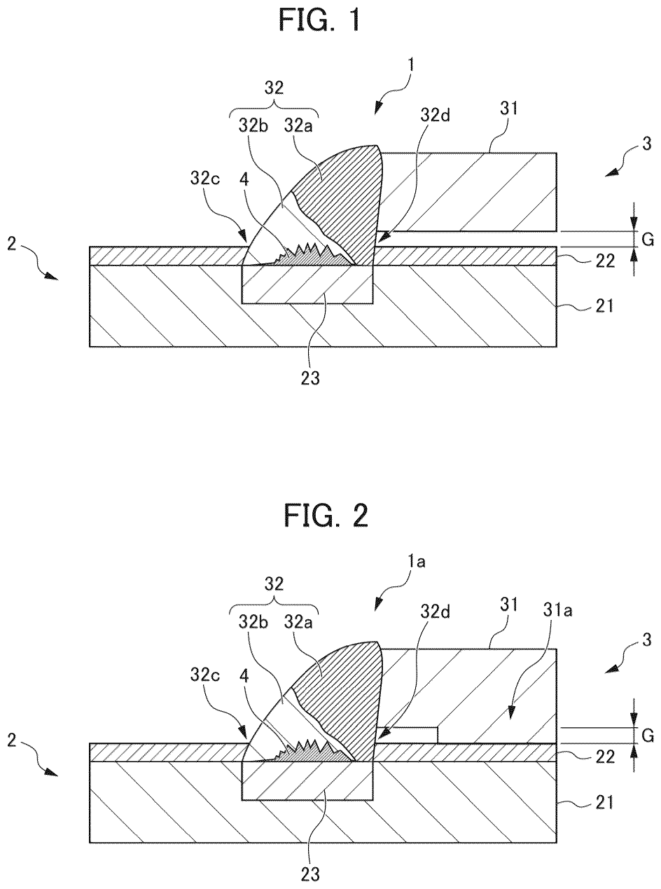

As shown in FIG. 1, a joined body 1 of the present embodiment is obtained by joining a first member 3 that is an aluminum-based material formed by high pressure die casting (HPDC) and a second member 2 made of a material different from the first member 3. The first member 3 has a melted-then-solidified part 32a that is melted and then solidified and contains less gas than a non-melted part. The first member 3 has a joint 32b that is joined to the second member 2 on one end of the first member 3 closer to the second member 2 than the melted-then-solidified part 32a. A HPDC aluminum material may contain gas such as hydrogen in the manufacturing process. However, the first member 3 is joined to the second member 2 on the one end of the first member 3 closer to the second member 2 than the melted-then-solidified part 32a containing less gas, providing the joined body 1 with desired joint strength.

### (First Member)

As shown in FIG. 1, the first member 3 includes a base material 31 and an end part 32. The end part 32 includes the melted-then-solidified part 32a and the joint 32b. As shown in FIG. 1, the joint 32b is formed at a portion closer to the one end of the first member 3 than the melted-then-solidified part 32a (formed at a portion adjacent to the second member 2, of the first member 3).

The melted-then-solidified part 32a is formed by high pressure die casting (HPDC) and then remolten to reduce the gas content. The melted-then-solidified part 32a may contain less gas than a non-melted part (the base material 31), for example, less than 5 cc of gas per 100 g of aluminum.

The joint 32b is a part that is molten and joined to the second member 2. The joint 32b provided at a portion closer to the one end of the first member 3 than the melted-then-solidified part 32a containing less gas increases not only the strength of the joint 32b, but also the strength around the joint 32b, providing the joined body 1 with desired joint strength. The joint 32b is preferably joined to a solid solution layer 23, which will be described later, of the second member 2.

The joint 32b, which may be part of the base material 31, may be made of a material different from the base material 31. The joint 32b may be made of, for example, brazing metal (such as an aluminum wire).

### (Second Member)

The second member 2 is made of a material different from the first member 3. The second member 2 is, for example, an iron member having a plating layer 22 on a base material 2. Any plating layer 22 may be formed, but a high melting point plating layer having a boiling point higher than the melting of the base material 21 is preferred. This plating layer 22 is not molten in a second step which will be described later. If the plating layer 22 is a Zn plating layer, for example, this configuration can keep the melting point of aluminum forming the first member 3 from decreasing due to a eutectic reaction between an ingredient of the plating layer 22 and an ingredient of the first member 3 mixed together. If the melting point of aluminum decreases, aluminum may flow into the solid solution layer formed in the second step, excessively producing an intermetallic compound.

The plating layer 22 may be, for example, an Fe—Al layer. Examples of the iron material having the Fe—Al layer include a high-tensile steel plate with an aluminum plating (e.g., an Al—Si alloy) on its surface. When the aluminum plating on the surface of the high-tensile steel plate is heated by hot stamping, the Fe—Al layer is formed on the surface.

The Fe—Al layer may contain an intermetallic compound. Any intermetallic compound, for example, an Al—Si—Fe intermetallic compound, may be contained. The Fe—Al layer may also contain an alloy, for example, an Fe—Al alloy, in addition to the intermetallic compound. The plating layer 22 on the other part of the second member 2 than the joint may have any thickness. The plating layer 22 may have a thickness in a range of, for example, 10 μm to 50 μm, or 20 μm to 40 μm.

The Fe—Al layer may have any melting point, for example, about 1280° C. to 1480° C. The melting point of the Fe—Al layer is closer to the melting point (1,560° C.) of iron (base material 21) than the melting point of a zinc-based plating, for example. Thus, if the Fe—Al layer only is molten to be joined to the first member 3, the Fe—Al layer needs to be molten at a temperature between the melting point of the Fe—Al layer and the melting point of the base material 21, making the temperature control difficult. In the present embodiment, the Fe—Al layer is molten with the base material 21 to form a solid solution layer 23, and the solid solution layer 23 is joined to the first member 3. This allows easy temperature control during the manufacture of the joined body 1.

The solid solution layer 23 is formed by solidifying at least part of the material forming the plating layer 22 with the base material 21. For example, the solid solution layer 23 is formed by solidifying aluminum contained in the Fe—Al layer as the plating layer 22 with the base material 21. When the HPDC aluminum material is joined to the solid solution layer 23, that is, the HPDC aluminum material is welded to a surface iron layer having no plating layer 22, the joined body 1 can be produced more easily than when the plating layer 22 and the first member 3 are directly welded. The solid solution layer 23 extends in the thickness direction of the second member 2 to reach the base material 21. The ratio of aluminum in the solid solution layer 23 solidified with iron, that is, the ratio of aluminum to iron in the solid solution layer 23, is preferably 10 mass % or less. The ratio of aluminum in the solid solution layer 23 set within the above range can keep the strength of the second member from decreasing due to the intermetallic compound formed without the solidification of aluminum.

When the joint 32b is joined to the solid solution layer 23, a thin intermetallic compound 4 can be formed between the first member 3 and the second member 2. The intermetallic compound 4 is thinner than the plating layer 22 on the other part of the second member 2 than the joint. The difference in thickness is remarkable at an end 32c and root 32d of the joint 32b shown in FIG. 1. Thus, it can be inferred that the material contained in the plating layer 22 (aluminum) is solidified with the base material 21.

Preferably, the thin intermetallic compound 4 only is present at the interface between the solid solution layer 23 and the joint 32b as shown in FIG. 1. Specifically, the joint 32b and the solid solution layer 23 are preferably diffusion joined by diffusion reaction. If the plating layer 22 having a thickness equal to that of the other part than the joint is present at the interface between the joint 32b and the solid solution layer 23, the diffusion reaction (movement of atoms) is inhibited, making the diffusion joining difficult.

As shown in FIG. 1, the first member 3 and the second member 2 are preferably spaced from each other by a predetermined distance G in a part other than the joint 32b and at least adjacent to the joint 32b. This can reduce excessive formation of the intermetallic compound caused by a first molten part 32a1 flowing into the solid solution layer 23 in a first step to be described later. As shown in FIG. 1, the first member 3 and the second member 2 may be spaced from each other in the whole part except for the end part 32.

### Second Embodiment

A joined body 1a according to a second embodiment will be described below with reference to FIG. 2. In the second embodiment, the same components as those described in the first embodiment are designated by the same reference numerals in the drawing, and the description of such components may be skipped.

As shown in FIG. 2, the joined body 1a includes a first member 3 having a stepped part 31a. The stepped part 31a is formed to have one end (adjacent to the second member 2) with a smaller cross sectional area than the other end (adjacent to the base material 31). This allows the first member 3 and the second member 2 to be spaced from each other by a predetermined distance G. The stepped part 31a provided for the first member 3 can easily keep the first member 3 and the second member 2 spaced from each other when joining the first member 3 and the second member 2. For the above advantage, the stepped part 31a preferably has a flat portion to be in contact with the second member 2.

### <Joining Method>

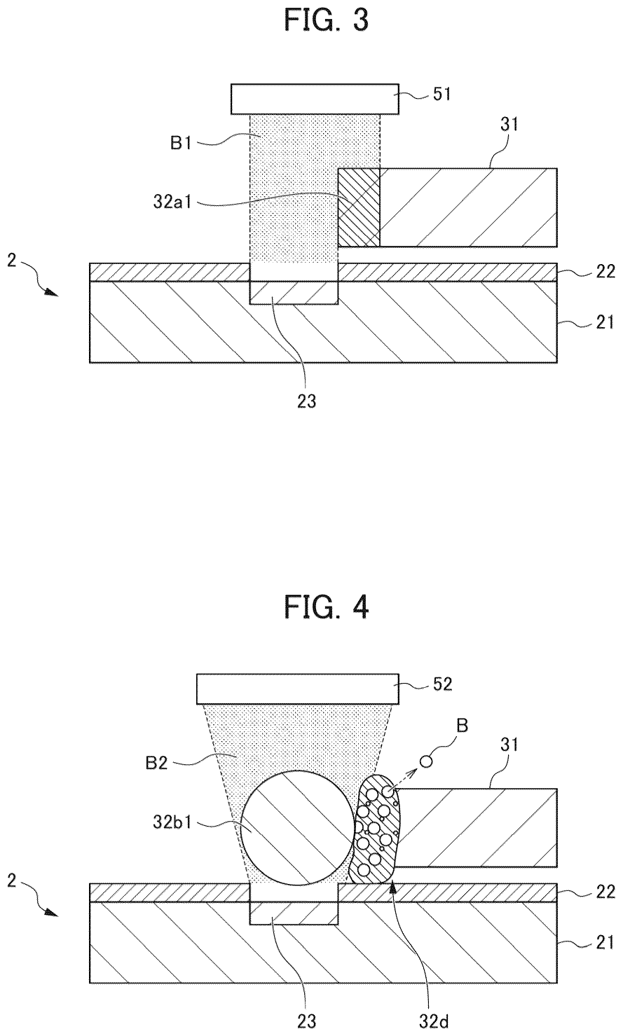

A method for joining the first member 3 and the second member 2 to obtain the joined body 1 will be described below with reference to FIGS. 3 and 4. The joining method of the present embodiment includes a first step of melting one end part of the first member to form a first molten part and a second step of melting a further end part of the first member than the first molten part formed by the first step to form a second molten part. In this method, the second molten part formed by the second step is joined to the second member.

In the first step, the one end part of the first member 3 is molten to form the first molten part 32a1, turning the gas present in the HPDC aluminum material into blowholes. The first molten part 32a1 is cooled and solidified after the second step to become the melted-then-solidified part 32a of the joined body 1. In the first step, any heat source may be used to melt the one end part of the first member, but for example, a laser beam B1 as shown in FIG. 3 is preferred. The one end part of the first member is irradiated with the laser beam B1 emitted from, for example, a laser device 51. In the following description, the laser beam will be described as the heat source, but any known heat source generally used for the welding such as an arc and an electron beam can also be used.

In the first step, it is preferable to melt the one end part of the first member 3 and at least part of the plating layer 22 on the surface of the second member 2. Preferably, in the first step, the first member 3 and the second member 2 are partially overlapped at a joining position as shown in FIG. 3, and the first member 3 is irradiated with the laser beam to heat the first member 3 and part of the second member 2. This single irradiation can solidify the plating layer 22 with the base material 21 to form the solid solution layer 23. In addition, part of the plating layer 22 overlapping with the first molten part 32a1 is not easily molten because heat is not easily transferred to the part. Further, the plating layer 22 is difficult to melt because of its high melting point. The first member 3 and the second member 2 are spaced from each other by a predetermined distance G. This can reduce excessive formation of the intermetallic compound caused by the first molten part 32a1 flowing into the plating layer 22.

Preferably, the heat applied in the first step is suitably controlled to be able to melt the first member 3 and form the solid solution layer 23. For example, if the plating layer 22 is an Fe—Al layer, the volumes of the plating layer 22 and the base material 21 to be molten are preferably controlled so that the content of aluminum in the solid solution layer 23 derived from the Fe—Al layer is 10 mass % or less of Fe. This can reduce the formation of the intermetallic compound, improving the strength of the joined body 1. The above control can be done by, for example, adjusting the temperature and irradiation time of the laser beam B1. Although a single laser beam is used, the first member 3 and the second member 2 absorb different amounts of heat due to the difference in material. Thus, the second member 2, if made of an iron material, rises in temperature more easily than the first member 3. In the first step, for example, the first member 3 may be heated at a temperature of about 800° C., and the second member 2 may be heated at a temperature of about 1,500° C. to 2,000° C.

In the first step, the one end part of the first member 3 may have a smaller cross sectional area than the other part for easy melting.

A step of cooling the first molten part 32a1 may be performed after the first step and before the second step. The cooling step can solidify the blowholes formed in the first molten part 32a1 in the first step (accumulate them in an upper portion of the first molten part 32a1). This allows easy release of the gas in the blowholes in the second step. The cooling step can also reduce a range of the first member 3 to be molten by heating in the second step, reducing the formation of additional blowholes. This can provide the joined body 1 with higher quality. The cooling step is performed between the first and second steps by setting a period of applying no heat of the laser beam or reducing the heat to be applied (e.g., by spacing the laser device from the first member).

The second step is a step of melting a further end part of the first member 3 than the first molten part 32a1 to form a second molten part 32b1. The second molten part 32b1 is cooled and solidified after the second step to become the joint 32b of the joined body 1. In the present embodiment, the first molten part 32a1 is formed at the end of the first member 3, and an aluminum wire is arranged and molten at the end of the first molten part 32a1 to form the second molten part 32b1. The second molten part 32b1 may be formed by any other process than the above, and may be formed by partially melting the base material 31.

In the second step, the second molten part 32b1 is formed, and the gas in the blowholes B solidified in the first molten part 32a1 is released outside. This can reduce the gas contained in the melted-then-solidified part 32a, improving the joint strength.

Any heat source may be used for forming the second molten part 32b1, but a laser beam B2 is preferred. Like the laser beam B1, the laser beam B2 is emitted from, for example, a laser device 52, to the second molten part 32b1. Any known heat source generally used for the welding such as an arc and an electron beam can replace the laser beam.

In the second step, the second molten part 32b1 is formed, and then joined to the second member 2. The second molten part 32b1 is preferably joined to the solid solution layer 23. The joining is preferably performed after the surface temperature of the solid solution layer 23 falls below its melting point. This can reduce excessive formation of the intermetallic compound. The joining is preferably performed in the presence of shielding gas for protecting the surface of the second member 2 from oxidation.

The embodiments of the present invention have been described above, but the present invention is not limited to the embodiments and may be modified or improved to the extent that the object of the invention can be achieved.

### EXPLANATION OF REFERENCE NUMERALS

1, 1a Joined body
2 Second member
21 Base material
22 Plating layer
23 Solid solution layer
3 First member
31a Stepped part
32a Melted-then-solidified part
32a1 First molten part
32b Joint
32b1 Second molten part

What is claimed is:

1. A joined body of a first member that is an aluminum-based material formed by high pressure die casting (HPDC) and
a second member made of a material different from the first member, wherein
the first member has a melted-then-solidified part that is melted and then solidified and contains less gas than a non-melted part, and
the first member has a joint that is joined to the second member on one end of the first member closer to the second member than the melted-then-solidified part.

2. The joined body according to claim 1, wherein the second member is made of an iron material and includes a base material and a plating layer formed on a surface of the base material,
the plating layer has a boiling point higher than a melting point of the base material, and
the joint is joined to a solid solution layer formed by solidifying at least part of a material forming the plating layer with the base material.

3. The joined body according to claim 1, wherein the first member and the second member are spaced from each other in a part other than the joint and at least adjacent to the joint.

4. The joined body according to claim 3, wherein the first member has a stepped part so that the one end has a smaller cross sectional area than an other end.

5. A method for joining a first member that is an aluminum-based material formed by high pressure die casting (HPDC) and
a second member made of a material different from the first member, the method comprising:
first melting one end part of the first member to form a first molten part; and
second melting a further end part of the first member than the first molten part formed by the first melting to form a second molten part, wherein
the second molten part of the first member formed by the second melting is joined to the second member.

6. The method according to claim 5, wherein the second member is made of an iron material and includes a base material and a plating layer formed on a surface of the base material,
the plating layer has a boiling point higher than a melting point of the base material, and
the first melting solidifies at least part of a material forming the plating layer with the base material to form a solid solution layer, and
the second melting joins the second molten part to the solid solution layer.

7. The method according to claim 6, wherein the second melting joins the second molten part to the solid solution layer after a surface temperature of the solid solution layer falls below its melting point.
